(19) United States
(12) Patent Application Publication
(10) Pub. No.: US 2025/0356246 A1
(43) Pub. Date: Nov. 20, 2025

(54) SYSTEMS AND METHODS FOR GENERATING SYNTHETIC TRAINING DATA

(71) Applicant: JPMORGAN CHASE BANK, N.A., New York, NY (US)

(72) Inventor: Poobalan KAMATCHI, South Brunswick, NJ (US)

(21) Appl. No.: 18/666,546

(22) Filed: May 16, 2024

(51) Int. Cl. G06N 20/00

(52) U.S. Cl. CPC G06N 20/00

(57) ABSTRACT

Systems and methods for generating synthetic training data are disclosed. A method may include: (1) receiving user speech from a user; (2) generating an input file comprising text of the user speech; (3) extracting entities from the text in the input file; (4) creating an input data structure for a data structure for the entities, wherein the input data structure comprises a plurality of columns, a column name for each column, a data attribute for each column, and a data type for each column, and a number of records based on a volume parameter; (5) converting the data type for each column to an ANSI SQL-standard data type; (6) generating a database agnostic data structure having the column names and the ANSI SQL-standard data type; (7) generating synthetic data for the database agnostic data structure; and (8) outputting an output file comprising the synthetic data.

### BACKGROUND OF THE INVENTION

### 1. Field of the Invention

Embodiments are generally directed to systems and methods for generating synthetic training data.

### 2. Description of the Related Art

As software is developed, it is tested by application developers and testers. Often, subsets of real customer data, including personal identifiable information, is used in this process. This leads to the risk of the potential for exposure of customer PII.

### SUMMARY OF THE INVENTION

Systems and methods for generating synthetic training data are disclosed. According to an embodiment, a method may include: (1) receiving, by a computer program executed by an electronic device, user speech from a user; (2) generating, by the computer program, an input file comprising text of the user speech; (3) extracting, by the computer program, entities from the text in the input file; (4) creating, by the computer program, an input data structure for a data structure for the entities, wherein the input data structure may include a plurality of columns, a column name for each column, a data attribute for each column, and a data type for each column, and a number of records based on a volume parameter; (5) converting, by the computer program, the data type for each column to an ANSI SQL-standard data type; (6) generating, by the computer program, a database agnostic ANSI SQL-standard data structure having the column names and the ANSI SQL-standard data type; (7) generating, by the computer program, synthetic data for the database agnostic data structure; and (8) outputting, by the computer program, an output file comprising the synthetic data.

In one embodiment, the entities may be extracted from the text of the input file using a plurality of pre-trained machine learning models.

In one embodiment, the entities comprise named entities, products, dates, and numerical values.

In one embodiment, the method may also include applying, by the computer program, pre-validations to the text in the input file.

In one embodiment, the method may also include prioritizing, by the computer program, the extracted entities.

In one embodiment, the method may also include: identifying, by the computer program, a data structure for the entities; and validating, by the computer program, the data structure with a user.

In one embodiment, the step of generating, by the computer program, synthetic data for the database agnostic data structure may include generating, by the computer program, randomized values for the records based on the data attribute, a seed value, and a total record value.

In one embodiment, the computer program may generate the synthetic data for a parent table and child tables.

In one embodiment, the method may also include verifying, by the computer program, that a threshold key distribution in the parent table and child tables is met.

In one embodiment, the method may also include masking, by the computer program, the synthetic data by reading column names and encrypting the synthetic data in the columns according to a parameter, wherein the parameter specifies whether encrypted values are allowed to repeat, whether encryption values are deterministic, whether patterned encryption is used, or whether partial encryption is used.

According to another embodiment, a method may include: (1) receiving, by a computer program executed by an electronic device, a sample data file comprising a plurality of columns and an input parameter file; (2) identifying, by the computer program, a statistical distribution of the columns in the sample data file; (3) generating, by the computer program, synthetic data for the columns based on the statistical distribution of the columns; and (4) writing, by the computer program, the synthetic data to an output file.

In one embodiment, the input parameter file may include a language for the synthetic data and geography details for the synthetic data.

In one embodiment, the method may also include normalizing, by the computer program, values based on the statistical distribution, wherein the statistical distribution of the columns may include a mean, a median, and a standard deviation for values in the columns having a numeric, integer, or decimal data type.

In one embodiment, the method may also include: identifying, by the computer program, a minimum date/time value and a maximum date/time value for values in the columns having a temporal data type; and generating, by the computer program, date/time values between the minimum and the maximum date/time values.

In one embodiment, the method may also include: identifying, by the computer program, unique values present in the sample data file, wherein the unique values comprise Boolean values; generating, by the computer program, random values by seeding the unique values; and distributing, by the computer program, the random values across a total number of records.

According to another embodiment, a non-transitory computer readable storage medium may include instructions stored thereon, which when read and executed by one or more computer processors, cause the one or more computer processors to perform steps comprising: receiving user speech from a user; generating an input file comprising text of the user speech; extracting entities from the text in the input file using a plurality of pre-trained machine learning models; creating an input data structure for a data structure for the entities, wherein the input data structure may include a plurality of columns, a column name for each column, and a data type for each column, and a number of records based on a volume parameter; converting the data type for each column to an ANSI SQL-standard data type; generating a database agnostic ANSI SQL-standard data structure having the column names and the ANSI SQL-standard data type; generating synthetic data for the database agnostic data structure; and outputting an output file comprising the synthetic data.

In one embodiment, the entities comprise named entities, products, dates, and numerical values.

In one embodiment, the non-transitory computer readable storage medium may also include instructions stored thereon, which when read and executed by the one or more computer processors, cause the one or more computer processors to perform steps comprising: identifying a data structure for the entities; and validating the data structure with a user.

In one embodiment, the synthetic data for the database agnostic data structure may be generated by generating for the records based on the data attribute, a seed value, and a total record value.

In one embodiment, the non-transitory computer readable storage medium may also include instructions stored thereon, which when read and executed by the one or more computer processors, cause the one or more computer processors to perform steps comprising: masking the synthetic data by reading column names and encrypting the synthetic data in the columns according to a parameter, wherein the parameter specifies whether encrypted values are allowed to repeat, whether encryption values are deterministic, whether patterned encryption is used, or whether partial encryption may be used.

### BRIEF DESCRIPTION OF THE DRAWINGS

For a more complete understanding of the present invention, the objects and advantages thereof, reference may be now made to the following descriptions taken in connection with the accompanying drawings in which:

FIGS. 1A and 1B depict systems for generating synthetic training data according to an embodiment;

FIG. 2 depicts a method for using a recommendation engine to generate synthetic data according to an embodiment;

FIG. 3 depicts a method for generating synthetic data using a native application according to an embodiment;

FIG. 4 depicts a method for randomizing synthetic data according to an embodiment;

FIG. 5 depicts a method for masking synthetic data according to an embodiment;

FIG. 6 depicts a method for data cloning according to an embodiment; and

FIG. 7 depicts an exemplary computing system for implementing aspects of the present disclosure.

### DETAILED DESCRIPTION OF PREFERRED EMBODIMENTS

Systems and methods for generating synthetic training data are disclosed.

Embodiments may generate real-world like datasets in non-production environments using an interactive user interface and artificial intelligence models that may generate voluminous synthetic system of record data that may be consumed by Application Programming Interfaces (APIs), files, databases, etc. Embodiments may leverage data structures and may standardize and generate voluminous synthetic data sets, may recommend custom-defined data structures, may generate voluminous data sets based on “parent-child” relationships, may clone data from a given representative dataset, may anonymize sensitive data at scale, etc.

Embodiments may provide an interactive user interface that allows a user to select, validate, and generate synthetic data sets using certain parameters. Embodiments may provide a recommendation engine that matches user inputs and prepares custom-defined data structures, a mapper that may convert a native database data structure to an ANSI-SQL standard (i.e., database agnostic, universally compatible) data structure, a globalizer that may enforce geography-based constraints, sampler artificial intelligence models that may increase or decrease a data relevancy, randomizer models that may encrypt sensitive data and/or clone input data sets, etc.

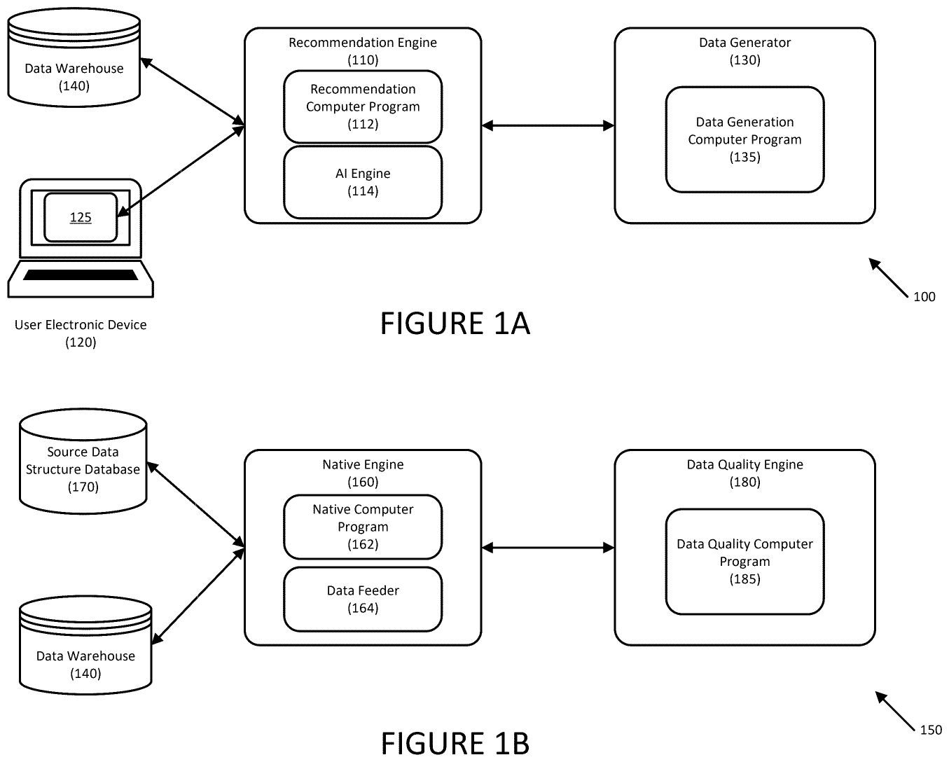

Referring to FIGS. 1A and 1B, systems for generating synthetic data are disclosed according to an embodiment. System 100 may include recommendation engine 110 that may be executed by an electronic device, such as a server (e.g., physical and/or cloud based), computers (e.g., workstations, desktops, laptops, notebooks, tablets, etc.), smart devices (e.g., smart phones, smart watches, etc.), Internet of Things (IoT) appliances, etc. Recommendation engine computer program 112 may receive user input, such as user speech, text, etc. from user computer program 125 that may be executed by user electronic device 120 (e.g., a computer, a smart device, an IoT appliance, etc.). User computer program 125 may receive user input from a user.

Recommendation engine 110 may also include artificial intelligence (AI) engine 114. AI engine 114 may interact with recommendation computer program 112. AI engine 114 may include a plurality of pre-trained models for named entity recognition, such as identifying and classifying named entities such as people, organizations, locations, products, dates, numerical values, languages; for recognizing an intent to identify the context of user input, semantic analysis may be on spoken text to understand the intended meaning of the request and relate to context, etc. The pre-trained models may use labeled data sets curated from source systems metadata.

In one embodiment, the user input may provide information on synthetic data to generate. Any suitable parameters may be received, including a quantity of synthetic data to generate, a type of synthetic data to generate (e.g., numerical such as credit card numbers, string, such as names, combinations, such as transactions, addresses, dates, etc.). Any suitable description of synthetic data may be received as may be necessary and/or desired.

Examples of synthetic data categories may include: string values such as entity names, resource names, school names, person names, Boolean values, or any values expressed in plain string etc., numeric values such as entity codes, identification numbers, etc.; temporal values, such as business transaction date, expiry date, start date, end date, etc.; decimal values, such as financial data, interest, premium amount, etc.; alphanumeric values, such as service line identifiers, product codes, pre-defined data values etc.

If the user input comprises user speech, the user speech may be converted to text by user computer program 125, or by any suitable mechanism.

Recommendation computer program 112 may extract entities from the user input and may extract entities using, for example, a Natural Language Understanding (NLU) engine (not shown), may identify metadata using an artificial intelligence engine, pre-trained knowledge corpus and may prepare a file, such as a JSON file with attributes, data types, tables, relations, and business rules. The file may be input to data generator 130, and data generation computer program 135 may generate the synthetic data according to the file. Data generation computer program 135 may call a plurality of functions, such as data generation functions. Examples of data generation functions may include a getData function (e.g., generates synthetic data based on the inputs such as name of the attribute, datatype, allowed values, key constraints such as unique, blanks and parent-key relations, and total number of records required); a getKey function (e.g., generate synthetic data based on the inputs such as isRepeat flag, name of the table, name of the key column, and total number of records required); a connectTable function (e.g., generate synthetic data based on the inputs such as name of the parent table, name of the child table, name of the parent key column, name of the child key column and total number of records required); a checkGlobal function (e.g., generate synthetic data based on the geography specific inputs such as globalCode, name of the attribute and total number of records required); a randomizeData function (e.g., randomize the data set based on the inputs such as attributeName, seedValue, and totalRecords); an encryptData function (e.g., encrypt the data based on the inputs such as isRepeat, tableName, columnName, and totalRecords); an encryptAuditTrail function (e.g., encrypt productionized data sets which are not registered in metadata catalog and explicitly documented the encryptions applied); and a getSample function (e.g., Generate synthetic data based on the inputs such as name of the attribute, datatype, allowed values, key constraints such as unique, blanks and parent-key relations in very small volume to verify and make changes in the input requirements based on generated synthetic data).

Recommendation engine 110 may interface with data warehouse 140, such as a cloud-based data warehouse. Data warehouse 140 may be a central repository that connects the related domain and fetches the corresponding data attributes for the domain.

Referring to FIG. 1B, system 150 may include native computer program 162 executed by native engine 160 may receive a source data structure from source data structure database 170 and may gather metadata. It may then read the database specific data structure and convert it to a database agnostic data structure (i.e., ANSI SQL standard) to facilitate universal database compatibility and reduces the data transformation overhead. A data feeder may receive the structures and may provide the data to data warehouse 140.

In one embodiment, native computer program 162 may generate synthetic data based on a known data structure and may populate the generated synthetic data into one or more target tables. Native computer program 162 may gather the data structure from source data structure database 170 of the source systems and may convert the database specific data structure into a database agnostic data structure (i.e., for each table/dataset in the source system the corresponding database agnostic data structure will be generated). For example, if the source may be database, native computer program 162 will leverage the source database data structure as-is, whereas if the source data structure may be file-based, native computer program 162 may generate a new data structure.

Data feeder 164 may receive an input file (e.g., a JSON file) and may generate synthetic data. For example, data feeder 164 may populate the source specific data structure and database agnostic data structure in the data warehouse as metadata. The synthetic data that may be generated may populate the ANSI-SQL standard, database agnostic data structure through Extract-Transform-Load (“ETL”) or a data loader utility of the chosen output database as is necessary and/or required.

Data quality engine 180 may execute data quality computer program 185. Data quality computer program 185 may call a plurality of functions, such as data quality functions. Examples of data quality functions may include a validateData function (e.g., Validate synthetic data generated based on the inputs such as name of the attribute, datatype, allowed values, key constraints such as unique, blanks and parent-key and totalRecords); a validateKey function (e.g., validate synthetic data based on the inputs such as isRepeat flag, name of the table, name of the key column, and total number of records required); a validateTable function (e.g., validate synthetic data based on the inputs such as name of the parent table, name of the child table, name of the parent key column, name of the child key column and total number of records required); a gatherMeta function (e.g., Gather the metadata from the sources based on the inputs such as name of the source, paramFile, or parameter file); a techQualityCheck function (e.g., technical data quality checks to be applied on the list of columns in the table based on the inputs such as name of the attribute, name of the table, and rule code/description); a businessQualityCheck function (e.g., business data quality checks to be applied on the list of columns in the table based on the inputs such as name of the attribute, name of the table, and rule code/description); a checkPII function (e.g., validate documented sensitive/confidential attributes and masking applied based on the inputs such as name of the attribute, name of the table, and may be partial flag); and a validateGlobal function (e.g., validate synthetic data based on the geography specific inputs such as globalCode, name of the attribute and total number of records required).

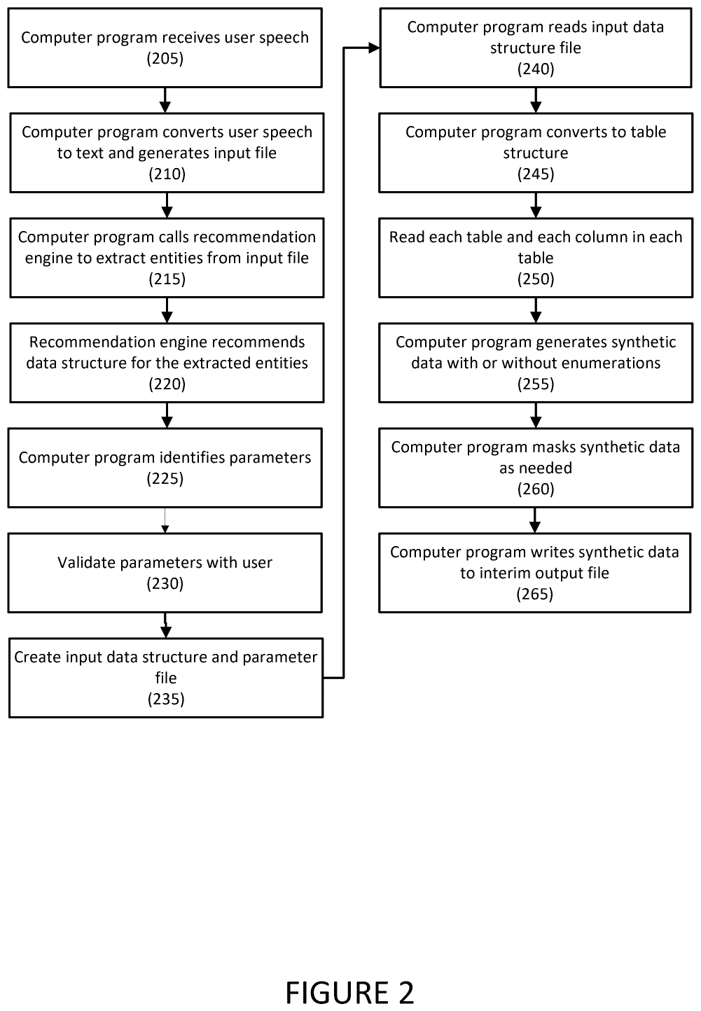

Referring to FIG. 2, a method for generating synthetic data using a recommendation engine may be disclosed according to an embodiment.

In step 205, a computer program may receive user speech, and in step 210, may convert the user speech into text. The text may be used to generate an input file.

In step 215, the computer program may call a recommendation engine to extract entities from the input file. In one embodiment, the computer program may use an AI engine to analyze the natural language in the input file to extract the entities. The AI engine may include a plurality of pre-trained models for named entity recognition, such as identifying and classifying named entities such as people, organizations, locations, products, dates, numerical values, languages; for recognizing an intent to identify the context of user input, semantic analysis may be on spoken text to understand the intended meaning of the request and relate to context, etc. The pre-trained models may use labeled data sets curated from source systems metadata.

The AI engine may receive the speech to text output, apply pre-validations to remove redundant words, lemmatize the words to recognize the varying forms of the same root word and meaning, tokenize the input text into multiple words to facilitate extracting entity names, features in the input text, assign ranking to features, compute similarity scores and then match with the labeled metadata.

The entities may be prioritized based on a line of business for an entity, domain/reference data (i.e., customer profiles, accounts, addresses, products, et al.) and transactional data (i.e., balances, corporate events, closures, payments, pricing, transactions, etc.). Based on the matching domain, the corresponding attributes will be shown and allow the user to approve or modify the recommended data structure.

In step 220, the recommendation engine may identify and/or recommend a data structure for the entities in the input file. An example data structure may include a domain and data attributes.

In one embodiment, the data attributes for the corresponding domains may be pre-populated as metadata in a data warehouse. The data warehouse may be a central repository that connects the related domain and fetches the corresponding data attributes for the domain.

An example of a domain may be a customer profile. For the customer profile domain, example data attributes may include a prefix, Customer Full Name, suffix, prefixes, first name, last name, date of birth, social security number, employer name, occupation, primary language, phone number, personal email, business email, veteran status, address, country, account numbers, passport number, credit score, etc.

In step 225, the computer program may identify parameters, such as the total number of records, the language, etc. for the data. In one embodiment, the parameters may be received in the user speech, or may be provided separately. An example of volume may be 1,500,000 synthetic records. An example of a language parameter may be English.

In one embodiment, if a parameter may be not provided, the computer program may use a default parameter (e.g., may use English as the language parameter.

In step 230, the computer program may validate the data structure and the parameters with the user. For example, the computer program may present the data structure and the parameters to the user, and the user may accept or modify the data structure or parameters.

After receiving user approval or modification, in step 235, the computer program may create an input data structure for the data structure, and a parameter file for the parameters. For example, the computer program may create a table based on the domain and the associated data attributes.

The input data structure may include the source file/table name, the column name, and data type details. A data type may be generally an indicator of the underlying data which may be a number, a string, dates, Boolean (yes/no, true/false, 0/1), etc., and must be present for each column name in the table/file. Illustrative examples may include: Table Name: Customer, Column Name: Customer_Name, Data type: String; Table Name: Account, Column Name: Account_Code, Data type: Integer; Table Name: LoanOrigination, Column Name: Loan_Amount, Data type: Decimal (18,2), Column Name: Is_Contractor, Data type: Boolean.

An example is as follows:

| Table Name | Column Name | Data type | Data definition |
|---|---|---|---|
| Customer | Customer_Name | String | Name of the |
| | | | customer |
| Customer | Date_of_birth | Date | Customer's date |
| | | | of birth |
| Account | Account_Code | Integer | Account number |
| LoanOrigination | Loan_Amount | Decimal (18, 2) | Loan amount |
| | | | applied |
| LoanOrigination | Is_delinquent | Boolean | Flag for |
| | | | delinquency |

In one embodiment, each table may include a number of rows equal to the volume parameter.

In step 240, the computer program may read the input data structure file.

In step 245, the computer program may convert the data type to an ANSI SQL compliant format and may generate a database agnostic data structure with same table name and column names as the table structure in the input data structure file, but with ANSI SQL compliant data types.

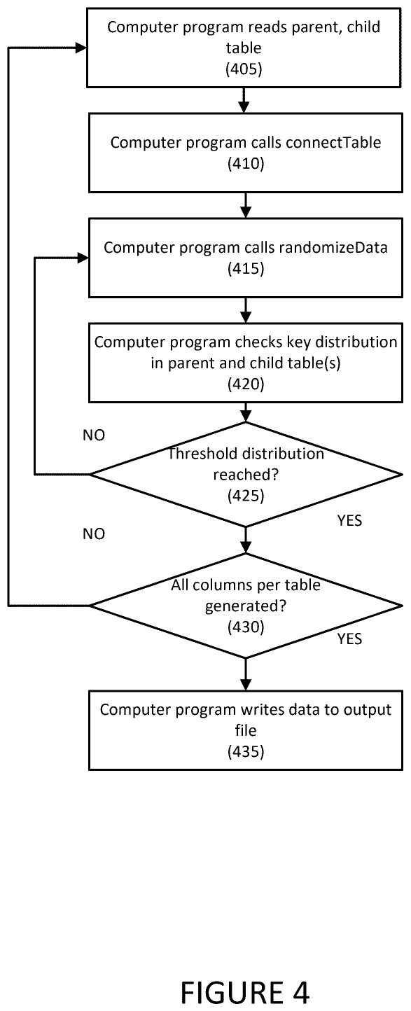

In step 250, the computer program may read each table and each column in each table, and in step 255, may generate synthetic data with or without enumerations as may be desired. This will be discussed in greater detail with regard to FIG. 4, below.

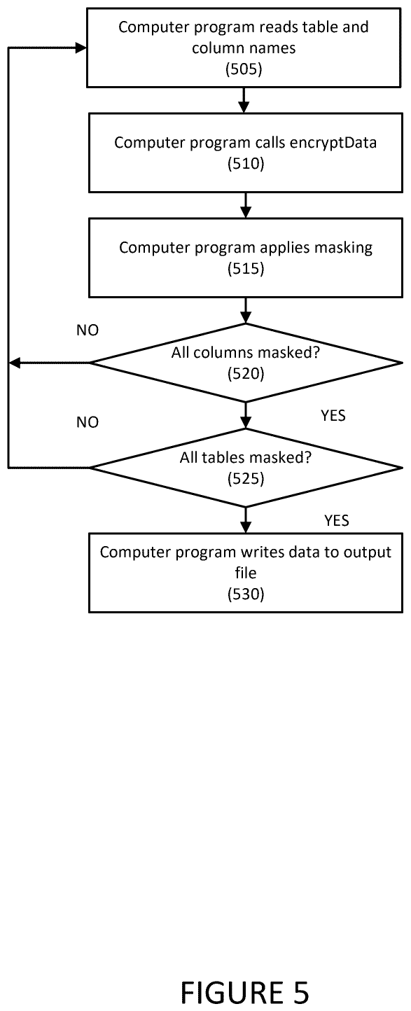

In step 260, the computer program may mask the synthetic data as needed. For example, the computer program may call a function to mask the data. This will be discussed in greater detail with regard to FIG. 5, below.

In step 265, the computer program may write the synthetic data to an interim output file.

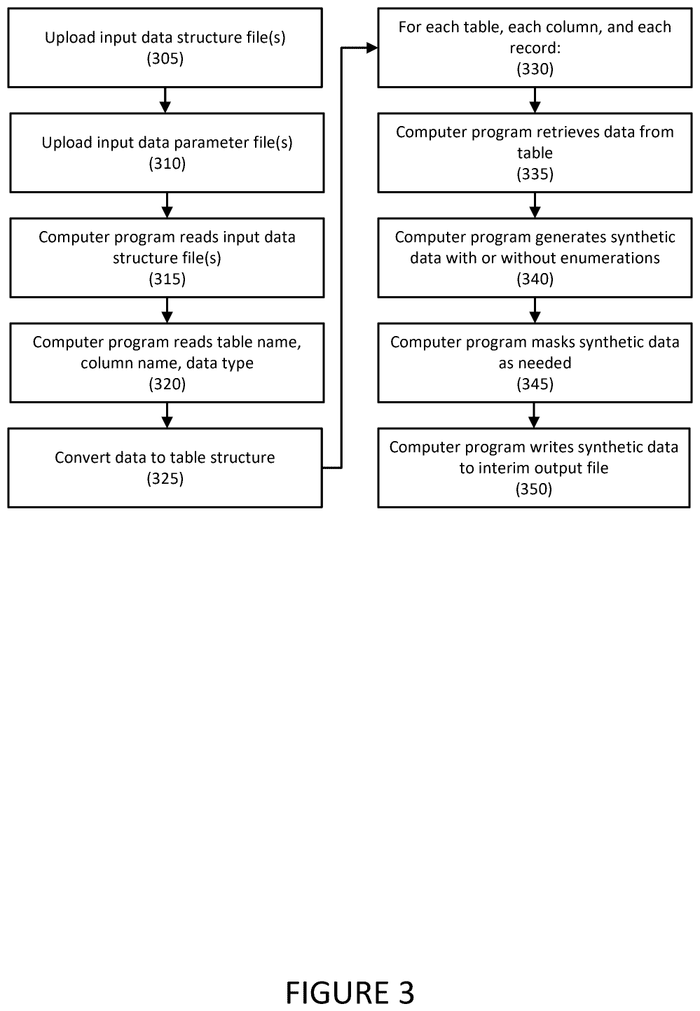

FIG. 3 depicts a method for generating synthetic data using a native application according to an embodiment.

In step 305, a computer program may upload an input data structure file(s), and in step 310, may upload one or more input data parameter file(s). In one embodiment, the input data parameter file(s) may be provided by a user.

In step 315, the computer program may read the input data structure file(s), and in step 320, may read the table name, column name, data type, etc. from each of the input data structure files.

In step 325, the computer program may convert the data type to an ANSI SQL compliant format and may generate a database agnostic data structure with same table name and column names as the table structure in the input data structure file, but with ANSI SQL standard data types.

In step 330, for each table, each column, and each record, in step 335, the computer program may retrieve data from the table. Examples of data that may be retrieved may include metadata of the table and column level such as a count of records, a count of unique records, a count of null values, a mean value of the column, a median value of the column, a standard deviation of the column, distinct values of the column, sensitive column or encrypted, a minimum value of the column. a maximum value of the column, the cardinality of the column (i.e., the number of unique values in the column versus the number of overall records), a default value of the column, etc.

The associated metadata may be gathered and stored in a data warehouse metadata table.

In step 340, the computer program may generate synthetic data with or without enumerations. This will be discussed in greater detail with regard to FIG. 4, below.

In step 345, the computer program may mask the synthetic data as needed. This will be discussed in greater detail with regard to FIG. 5, below.

In step 350, the computer program may write the synthetic data to an interim output file.

Referring to FIG. 4, a method for generating synthetic data may be disclosed according to an embodiment.

In step 405, a computer program may read a parent and a child table, which may be the result of a function to gather metadata on for all pre-existing source tables/files, and in step 410, may call a function to generate synthetic data based on the inputs such as the name of the parent table, the name of the child table, the name of the parent key column, the name of the child key column and the volume of synthetic records to be generated. An example of such a function may be the connectTable function.

The function may generate synthetic data for parent, child table using a function for the total number of records mentioned in the input parameter totalRecords.

In one embodiment, the function may update data warehouse metadata entries with the parent table, list of associated child tables, parent key column, child key column(s), etc.

In step 415, the computer program may call a function to generate randomized values of the attribute's value based on the inputs such as attributeName, seedValue and totalRecords. Using the same seed value will generate the same randomized value as deterministic each time the function may be executed; different seed value will generate different randomized value as non-deterministic and ensues completely random value for each execution. An example of such a function may be the randomizeData function. The randomizeData function may randomize the data based on the totalRecords parameter, so it can randomize all rows, or just a subset of the rows.

In step 420, the computer program may check a key distribution in the parent and child tables. For example, the compute program may compare a key column data distribution in parent and child tables to ensure that child table contains either a subset of keys or complete set of keys present in the parent table. Checking the key distribution in both parent and child table will ensure the parent-child relationship may be intact. The keys represent the actual numeric values synthetically generated for both parent and child tables, and a function, such as the getKey( ) function, may generate the key values for parent and child tables.

In step 425, the computer program may check to see if a threshold distribution may be reached. The threshold may be based on the data volume input parameter. For example, to check the threshold distribution that may be reached, the computer program may compare the parent and child table key values and the count of differing key values should match with the totalRecords/Threshold input. If it is not, the process may return to step 415.

In step 430, if the threshold distribution may be reached, the computer program may check to see if all columns for the child tables have been generated with randomized data.

If all columns have not been generated, the process may return to step 405.

If all columns have been generated, in step 435, the computer program may write the generated synthetic data output to an output data file. The output data file may then be loaded to the output file through ETL, a data loader utility, etc.

FIG. 5 depicts a method for masking synthetic data according to an embodiment.

In step 505, a computer program may read table and column names for a table, and in step 510, may call a function to encrypt the data in the table. An example function may be the encryptData function.

For example, in order to apply the masking on specific column in the table, the compute program may read the table and column names and start masking in multiple tables simultaneously.

In one embodiment, the data encryption may be based on an encryption algorithm with or sans an encryption key, and managed through an input parameter, such as isRepeat.

For example, if the input parameter may be set to 1, then non-deterministic encryption may be applied so the encrypted values are not repeating for the column each time.

If the input parameter may be set to 2, then repeatable encryption may be used so the encrypted values will be deterministic for the column, and result in same encrypted values.

If the input parameter may be set to 3, then patterned encryption may be used so the encrypted column values are substituted with * (asterisk) or #(hash) or (−).

If the input parameter may be set to 4, then partial encryption may be applied to the column values (e.g., 4 characters).

In step 515, the computer program may apply masking to the data. For example, the computer program may read the column values from the table, and apply a masking format based on the parameter value.

In step 520, the computer may check to see if all columns of the table are masked. If they are not, the process may return to step 505 to select the next column.

If all columns are masked, in step 525, the computer program may check to see if all tables are masked. If they are not, the process may return to step 505 to select the next table.

If all tables and column have been masked, in step 530, the computer program may write the masked values to the table's column(s) through an ETL, a database loader utility, or a computer program.

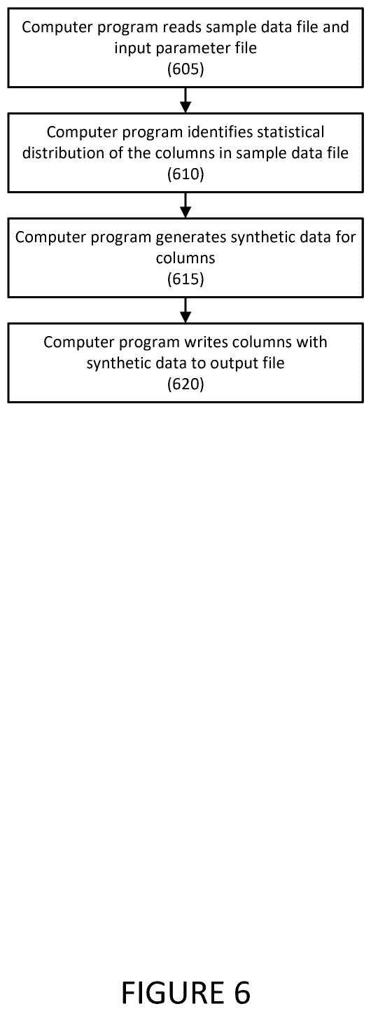

FIG. 6 depicts a method for cloning data that may be disclosed according to an embodiment.

In step 605, the computer program may read a sample data file and an input parameter file. For example, the sample data file may include a limited volume of the actual data (e.g., a few hundred records) to be synthetically cloned by taking the columns present in the sample data file and the columns' statistical distribution. The input parameter file may include the language to generate synthetic data (e.g., English), geography details (e.g., USA, UK, Australia et al), and time period for generating if any historical synthetic data, a total number of synthetic data records to create and an indicator flag for creating the synthetic data based on the statistical distribution present in the sample data file or not.

In step 610, the computer program may identify a statistical distribution of the columns in the sample data file.

In step 615, the computer program may generate synthetic data for the columns in the sample data file using the statistical distribution of the columns. In one embodiment, the computer program may identify the data type of the column (majorly number, string, date, Boolean, etc.) for which the synthetic data may be generated and may identify the statistical distribution of the column.

For example, for columns having a numeric, integer, or decimal datatypes, the computer program may identify the statistical distribution (e.g., the mean, median, standard deviation) of the column and may normalize the values and assign these values for the total number of records. Following this, the column values across the total number of records are within the range of mean and standard deviation.

For columns with a temporal data type, the computer program may identify the minimum date/time value and maximum date/time value and may generate the date/time values between the minimum and maximum date/time values. Following this, the column values across the total number of records are within the range of minimum and maximum temporal values.

For columns with a string or Boolean data type, the computer program may identify the unique values present in the sample data file for respective column(s) and may generate random values by seeding the unique values and distributing the randomized values across the total number of records. Following this, the column values across the total number of records are randomized string values.

In another embodiment, if the indicator flag indicates that the statistical distribution of the columns is not to be used (e.g., the indicator flag is set to “No”), the computer program may generate synthetic data for each unique occurrence of the record from the input sample data file. After it generates the synthetic data for the total number of records, the computer program may randomize the synthetic data. Thus, the final output synthetic data may be similar to the input sample data but scaled per total number of records.

In step 620, the computer program may write the columns with synthetic data to an output file to enable the data load may be handled through an ETL or a data loader utility etc.

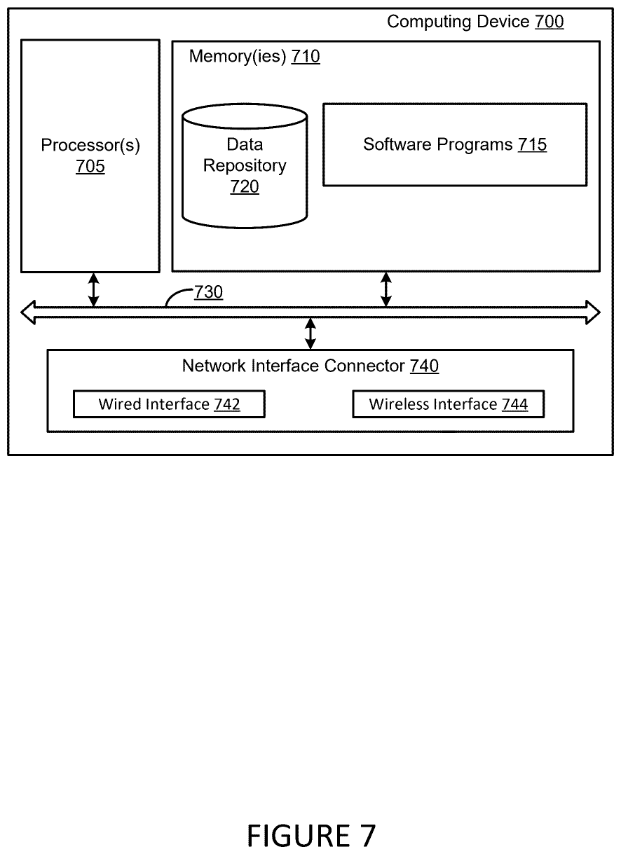

FIG. 7 depicts an exemplary computing system for implementing aspects of the present disclosure. FIG. 7 depicts exemplary computing device 700. Computing device 700 may represent the system components described herein. Computing device 700 may include processor 705 that may be coupled to memory 710. Memory 710 may include volatile memory. Processor 705 may execute computer-executable program code stored in memory 710, such as software programs 715. Software programs 715 may include one or more of the logical steps disclosed herein as a programmatic instruction, which may be executed by processor 705. Memory 710 may also include data repository 720, which may be nonvolatile memory for data persistence. Processor 705 and memory 710 may be coupled by bus 730. Bus 730 may also be coupled to one or more network interface connectors 740, such as wired network interface 742 or wireless network interface 744. Computing device 700 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” may be to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that may be capable of implementing the steps of the processes disclosed herein.

The processing machine used to implement embodiments may utilize a suitable operating system.

It may be appreciated that in order to practice the method of the embodiments as described above, it may be not necessary that the processors and/or the memories of the processing machine be physically located in the same geographical place. That is, each of the processors and the memories used by the processing machine may be located in geographically distinct locations and connected so as to communicate in any suitable manner. Additionally, it may be appreciated that each of the processor and/or the memory may be composed of different physical pieces of equipment. Accordingly, it may be not necessary that the processor be one single piece of equipment in one location and that the memory be another single piece of equipment in another location. That is, it may be contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, may be performed by various components and various memories. However, it may be appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it may be appreciated that the instructions or set of instructions used in the implementation and operation of embodiments may be in a suitable form such that the processing machine may read the instructions. For example, the instructions that form a program may be in the form of a suitable programming language, which may be converted to machine language or object code to allow the processor or processors to read the instructions. That is, written lines of programming code or source code, in a particular programming language, are converted to machine language using a compiler, assembler or interpreter. The machine language may be binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It may be to be appreciated that the set of instructions, i.e., the software for example, that enables the computer operating system to perform the operations described above may be contained on any of a wide variety of media or medium, as desired. Further, the data that may be processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as may be desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface may be any device that provides communication between a user and a processing machine. The information provided by the user to the processing machine through the user interface may be in the form of a command, a selection of data, or some other input, for example.

As discussed above, a user interface may be utilized by the processing machine that performs a set of instructions such that the processing machine processes data for a user. The user interface may be typically used by the processing machine for interacting with a user either to convey information or receive information from the user. However, it should be appreciated that in accordance with some embodiments of the system and method, it may be not necessary that a human user actually interact with a user interface used by the processing machine. Rather, it may be also contemplated that the user interface might interact, i.e., convey and receive information, with another processing machine, rather than a human user. Accordingly, the other processing machine might be characterized as a user. Further, it may be contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it may be to be understood that this disclosure may be only illustrative and exemplary of the present invention and may be made to provide an enabling disclosure of the invention. Accordingly, the foregoing disclosure may be not intended to be construed or to limit the present invention or otherwise to exclude any other such embodiments, adaptations, variations, modifications or equivalent arrangements.

What may be claimed is:

1. A method, comprising:
receiving, by a computer program executed by an electronic device, user speech from a user;
generating, by the computer program, an input file comprising text of the user speech;
extracting, by the computer program, entities from the text in the input file;
creating, by the computer program, an input data structure for a data structure for the entities, wherein the input data structure comprises a plurality of columns, a column name for each column, a data attribute for each column, and a data type for each column, and a number of records based on a volume parameter;
converting, by the computer program, the data type for each column to an ANSI SQL-standard data type;
generating, by the computer program, a database agnostic ANSI SQL-standard data structure having the column names and the ANSI SQL-standard data type;
generating, by the computer program, synthetic data for the database agnostic ANSI SQL-standard data structure; and
outputting, by the computer program, an output file comprising the synthetic data.

2. The method of claim 1, wherein the entities are extracted from the text of the input file using a plurality of pre-trained machine learning models.

3. The method of claim 1, wherein the entities comprise named entities, products, dates, and numerical values.

4. The method of claim 1, further comprising:
applying, by the computer program, pre-validations to the text in the input file.

5. The method of claim 1, further comprising:
prioritizing, by the computer program, the extracted entities.

6. The method of claim 1, further comprising:
identifying, by the computer program, a data structure for the entities; and
validating, by the computer program, the data structure with a user.

7. The method of claim 1, wherein the step of generating, by the computer program, synthetic data for the database agnostic data structure comprises generating, by the computer program, randomized values for the records based on the data attribute, a seed value, and a total record value.

8. The method of claim 7, wherein the computer program generates the synthetic data for a parent table and child tables.

9. The method of claim 8, further comprising:
verifying, by the computer program, that a threshold key distribution in the parent table and child tables may be met.

10. The method of claim 1, further comprising:
masking, by the computer program, the synthetic data by reading column names and encrypting the synthetic data in the columns according to a parameter, wherein the parameter specifies whether encrypted values are allowed to repeat, whether encryption values are deterministic, whether patterned encryption may be used, or whether partial encryption may be used.

11. A method, comprising:
receiving, by a computer program executed by an electronic device, a sample data file comprising a plurality of columns and an input parameter file;
identifying, by the computer program, a statistical distribution of the columns in the sample data file;
generating, by the computer program, synthetic data for the columns based on the statistical distribution of the columns; and
writing, by the computer program, the synthetic data to an output file.

12. The method of claim 11, wherein the input parameter file comprises a language for the synthetic data and geography details for the synthetic data.

13. The method of claim 11, further comprising:
normalizing, by the computer program, values based on the statistical distribution, wherein the statistical distribution of the columns comprises a mean, a median, and a standard deviation for values in the columns having a numeric, integer, or decimal data type.

14. The method of claim 11, further comprising:
identifying, by the computer program, a minimum date/time value and a maximum date/time value for values in the columns having a temporal data type; and
generating, by the computer program, date/time values between the minimum and the maximum date/time values.

15. The method of claim 11, further comprising:
identifying, by the computer program, unique values present in the sample data file, wherein the unique values comprise Boolean values;
generating, by the computer program, random values by seeding the unique values; and
distributing, by the computer program, the random values across a total number of records.

16. A non-transitory computer readable storage medium, including instructions stored thereon, which when read and executed by one or more computer processors, cause the one or more computer processors to perform steps comprising:
receiving user speech from a user;
generating an input file comprising text of the user speech;
extracting entities from the text in the input file using a plurality of pre-trained machine learning models;
creating an input data structure for a data structure for the entities, wherein the input data structure comprises a plurality of columns, a column name for each column, and a data type for each column, and a number of records based on a volume parameter;
converting the data type for each column to an ANSI SQL-standard data type;
generating a database agnostic ANSI SQL-standard data structure having the column names and the ANSI SQL-standard data type;
generating synthetic data for the database agnostic ANSI SQL-standard data structure; and
outputting an output file comprising the synthetic data.

17. The non-transitory computer readable storage medium of claim 16, wherein the entities comprise named entities, products, dates, and numerical values.

18. The non-transitory computer readable storage medium of claim 16, further including instructions stored thereon, which when read and executed by the one or more computer processors, cause the one or more computer processors to perform steps comprising:
identifying a data structure for the entities; and
validating the data structure with a user.

19. The non-transitory computer readable storage medium of claim 16, wherein the synthetic data for the database agnostic data structure may be generated by generating for the records based on a seed value and a total record value.

20. The non-transitory computer readable storage medium of claim 16, further including instructions stored thereon, which when read and executed by one or more computer processors, cause the one or more computer processors to perform steps comprising:
masking the synthetic data by reading column names and encrypting the synthetic data in the columns according to a parameter, wherein the parameter specifies whether encrypted values are allowed to repeat, whether encryption values are deterministic, whether patterned encryption may be used, or whether partial encryption may be used.
